(19) United States
(12) Patent Application Publication
(10) Pub. No.: US 2008/0309029 A1
(43) Pub. Date: Dec. 18, 2008

(54) Chuck jaw face profile

(76) Inventors: Thomas Jay Bodine, Glenwood, MD (US); Rickey J. Thomas, Manchester, MD (US)

Correspondence Address: HARNESS, DICKEY & PIERCE, P.L.C., P.O. BOX 8910, RESTON, VA, 20195, US

(21) Appl. No.: 12/155,147

(22) Filed: May 30, 2008

Related U.S. Application Data
(60) Provisional application No. 60/941,094, filed on May 31, 2007.

(51) Int. Cl. B23B 31/16

(52) U.S. Cl. 279/60; 279/123; 279/158

(57) ABSTRACT

A chuck is described. The chuck may include: a plurality of chuck jaws. Each chuck jaw is radially movable toward and way from a chuck axis, and each chuck jaw including: two substantially coplanar surfaces perpendicular to a chuck jaw axis and substantially parallel to the chuck axis; a ridge located between the two substantially coplanar surfaces; and two troughs, one trough located between the ridge and one of the substantially coplanar surface and the other trough located between the ridge and the other coplanar surface. A chuck jaw and method of configuring a chuck are also described.

### CROSS-REFERENCE TO RELATED APPLICATIONS

This application claims priority to provisional U.S. patent application entitled, Chuck Jaw Face Profile, filed May 31, 2007, having a Ser. No. 60/941,094, the disclosure of which is hereby incorporated by reference in its entirety.

### BACKGROUND

1. Field

Example embodiments relate in general to tool chucks for attachment of accessories to power drivers, and more particularly to jaws of a tool chuck for clamping accessories.

2. Description of Related Art

A conventional tool chuck may have a body that moveably supports jaws. The tool chuck may be actuated (via a variety of mechanisms) to move the jaws for gripping an accessory. The jaws may grip a variety of accessories, including ones with smooth (or round) shanks, ones with hexagonal shanks (“hex shank accessories”) and ones with round shanks having flats, for example. The surface of the jaw that contacts and grips the accessory will be referred to as a “jaw face.”

The jaw face may extend parallel to (and face toward) an axis of the tool chuck. Numerous and varied jaw face geometries are well known in this art. For example, a jaw may implement a planar jaw face. A planar jaw face may allow an accessory having a round shaft to undesirably rotate (or slip) relative to the tool chuck during use. According to conventional wisdom, therefore, one or more ridges may be implemented on the jaw face to provide improved shaft hold.

Although conventional jaw face geometries are generally thought to provide acceptable performance, they are not without shortcomings. For example, in some applications (e.g., where the applied torque may exceed 600 in-lbs), the ridge on the jaw face may deform, burr and/or generally deteriorate the shanks of the accessories.

### SUMMARY

According to an example, non-limiting embodiment, a jaw may include a body with a jaw face. The jaw face may have a ridge interposed between two flats defining a reference plane. A peak of the ridge may not extend beyond the reference plane.

In accordance with one example embodiment in accordance with the present invention, a chuck is provided. The chuck may include: a plurality of chuck jaws, each chuck jaw radially movable toward and way from a chuck axis, each chuck jaw including: two substantially coplanar surfaces perpendicular to a chuck jaw axis and substantially parallel to the chuck axis; a ridge located between the two substantially coplanar surfaces; and two troughs, one trough located between the ridge and one of the substantially coplanar surface and the other trough located between the ridge and the other coplanar surface.

In accordance with one example embodiment in accordance with the present invention, a method of configuring a chuck is provided. The method may include: providing a chuck jaw having a flat face, the flat face perpendicular to a chuck jaw axis and substantially parallel to a chuck axis; defining a ridge in the chuck jaw by forming two troughs in the flat face running substantially parallel to the chuck axis; and dimensioning and locating the ridge and the flat face so that when the chuck is engaged with a round shank, the ridge and not the flat face engages the shank and when the chuck engages an accessory with flats, the flat face engages the flats.

In accordance with one example embodiment in accordance with the present invention, a chuck jaw is provided. The chuck jaw may include: two substantially coplanar surfaces perpendicular to a chuck jaw axis and substantially parallel to the chuck axis; a ridge located between the two substantially coplanar surfaces; two troughs, one trough located between the ridge and one of the substantially coplanar surface and the other trough located between the ridge and the other coplanar surface; and two flat angled sides, each of the two flat angled sides oriented at an angle that allows the flat angled sides to abut against a flat angled side of an adjunct chuck jaw when the jaws in the chuck are closed.

The above and other features of example embodiments including various and novel details of construction and combinations of parts will now be more particularly described with reference to the accompanying drawings. It will be understood that the details of the example embodiments are shown by way of illustration only and not as limitations of the example embodiments. The principles and features of this invention may be employed in varied and numerous embodiments without departing from the spirit and scope of the invention.

### BRIEF DESCRIPTION OF THE DRAWINGS

Example, non-limiting embodiments will be described with reference to the accompanying drawings, wherein like elements are represented by like reference numerals.

FIG. 1 is a front view of a jaw according to an example, non-limiting embodiment.

FIG. 2-6 are schematic views of three of the jaws shown in FIG. 1 gripping accessories.

FIG. 7 a front view of a jaw according to another example, non-limiting embodiment.

FIGS. 8-12 are schematic views of three of the jaws shown in FIG. 7 gripping accessories.

FIG. 13 is side view of jaws in accordance with an example embodiment in a chuck in a power driver.

FIG. 14 is a front view of a jaw according to another example, non-limiting embodiment.

FIG. 15 is a front view of a jaw according to another example, non-limiting embodiment.

### DESCRIPTION OF EXAMPLE, NON-LIMITING EMBODIMENTS

The following example, non-limiting embodiments are described with respect to a tool chuck having three jaws, which may be spaced circumferentially 120° apart from each other. In alternative embodiments, more or less than three jaws may be suitably implemented, and/or the circumferential spacing between the jaws may be varied Further, it will be readily apparent that the example jaw faces described below may be suitably implemented on threaded jaws (having a back surface with threads), as well as pusher style jaws (which are threadless).

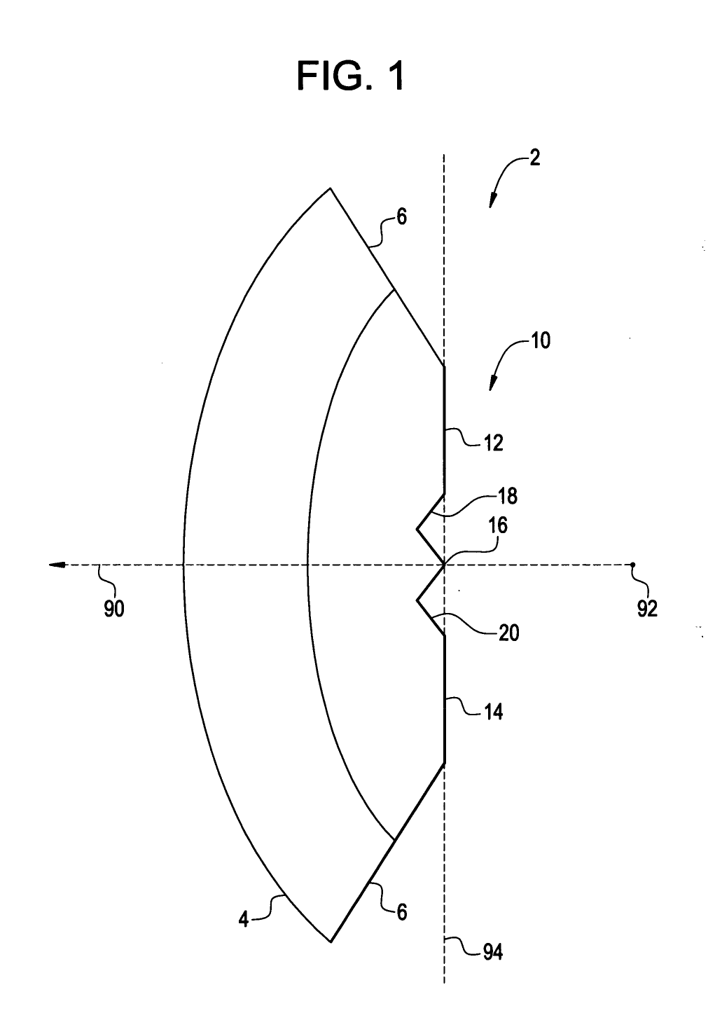

I. Example Embodiment Depicted in FIGS. 1-6:

With reference to FIG. 1, the jaw 2 may include a jaw face 10 and a back surface 4 opposite the jaw face 10. Side surfaces 6 may extend between the back surface 4 and the jaw face 10. By way of example only, the side surfaces 6 may define an angle of 120°, and each side surface 6 may be parallel to a side surface of an adjacent jaw. Thus, when the tool chuck is fully closed, the side surfaces 6 of adjacent jaws 2 may abut against each other. The side surfaces 6 may include a chamfer at the jaw face 10 and/or the back surface 4.

As shown, the jaw face 10 may include a pair of flats 12, 14. The flats 12, 14 may be provided on either side of a jaw axis 90 that extends in a radial outward direction from a tool chuck axis 92 (which extends into the drawing sheet). The flats 12, 14 may be perpendicular to the jaw axis 90 and parallel to the tool chuck axis 92. By way of example only, the flats 12, 14 may be of the same size.

The jaw face 10 may also include a ridge 16 located between the flats 12, 14. The ridge 16 may be parallel to the tool chuck axis 92 and centered on the jaw axis 90. The ridge 16 may have little or no rounding, as shown. Those skilled in the art will appreciate, however, that typical manufacturing processes and chuck use may round the ridge 16. In this example embodiment, the ridge 16 and the flats 12, 14 may lie in a common reference plane 94 (which is parallel to the tool chuck axis 92).

Respective troughs 18, 20 may be situated between the ridge 16 and each of the flats 12, 14. By way of example only, the troughs 18, 20 may have a “V” shaped cross section. In alternative embodiments, troughs having numerous and varied shapes may be suitably implemented. For example, the trough may have planar walls (as shown), walls with curved contours, and/or walls with stepped contours. Further, the trough may have a uniform cross sectional shape, or the cross sectional shape may be varied along the length of the trough. The troughs 18, 20 may have the same shape, as shown. In alternative embodiments, the troughs may have different shapes.

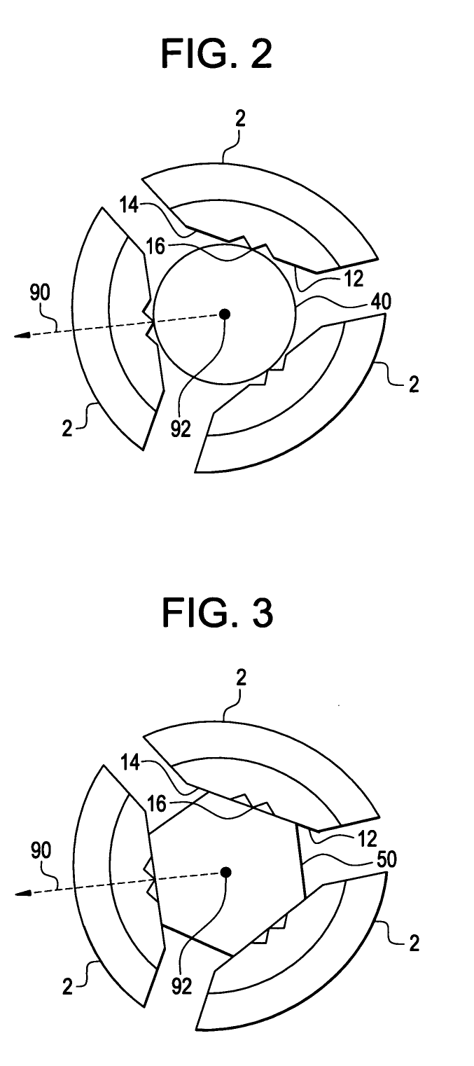

As described below with reference to FIGS. 2-6, accessories having smooth (or round) shanks may be gripped by the ridge 16 of the jaw face 10, and accessories having shanks with flats may be gripped by the flats 12, 14 of the jaw face 10. FIGS. 2-6 illustrate the spatial arrangement between the jaws 2 of a three-jaw chuck.

FIG. 2 illustrates the jaws 2 gripping an accessory having a relatively small round shank 40 (e.g., a ¼″ round shank). Here, the ridge 16 of each jaw 2 may grip the round shank 40, while the flats 12, 14 of each jaw 2 may be spaced apart from the round shank 40. In this way, the flats 12, 14 may not interfere with the “biting” action of the ridges 16 into the round shank 40

FIG. 3 illustrates the jaws 2 gripping an accessory having a relatively small hex shank 50 (e.g., a ¼″ hex shank). Here, the ridge 16 and the flats 12, 14 of each jaw 2 may grip the hex shank 50.

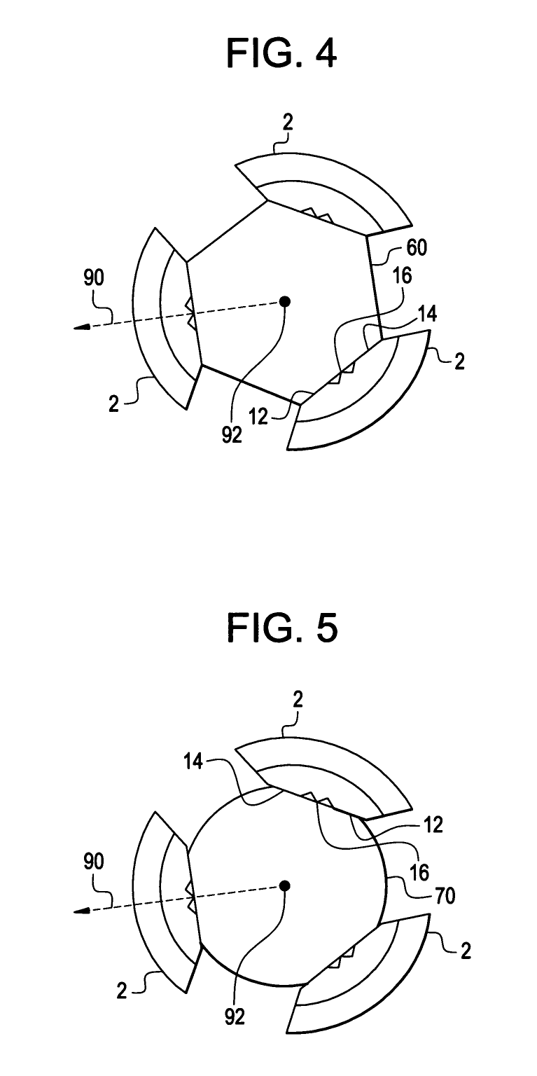

FIG. 4 illustrates the jaws 2 gripping an accessory having a relatively large hex shank 60 (e.g., a 7/16″ hex shank). Here, the ridge 16 and the flats 12, 14 of each jaw 2 may grip the hex shank 60.

FIG. 5 illustrates the jaws 2 gripping an accessory having a relatively large round shank 70 with flats (e.g., a ½″ round shank with flats). Here, the ridge 16 and the flats 12, 14 of each jaw 2 may grip the shank 70.

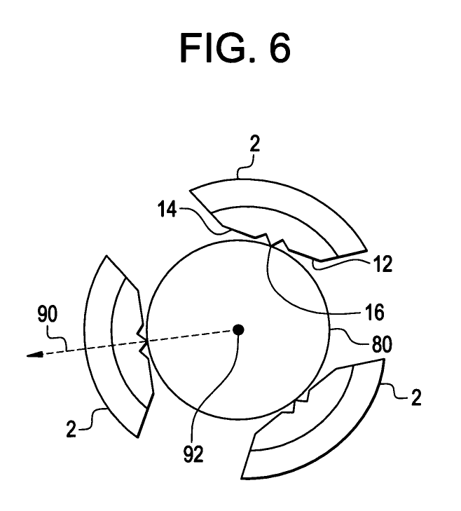

FIG. 6 illustrates the jaws 2 gripping an accessory having a relatively large round shank 80 (e.g., a ½″ round shank). Here, the ridge 16 of each jaw 2 may grip the round shank 80, while the flats 12, 14 of each jaw 2 may be spaced apart from the round shank 80. In this way, the flats 12, 14 may not interfere with the “biting” action of the ridges 16 into the round shank 80.

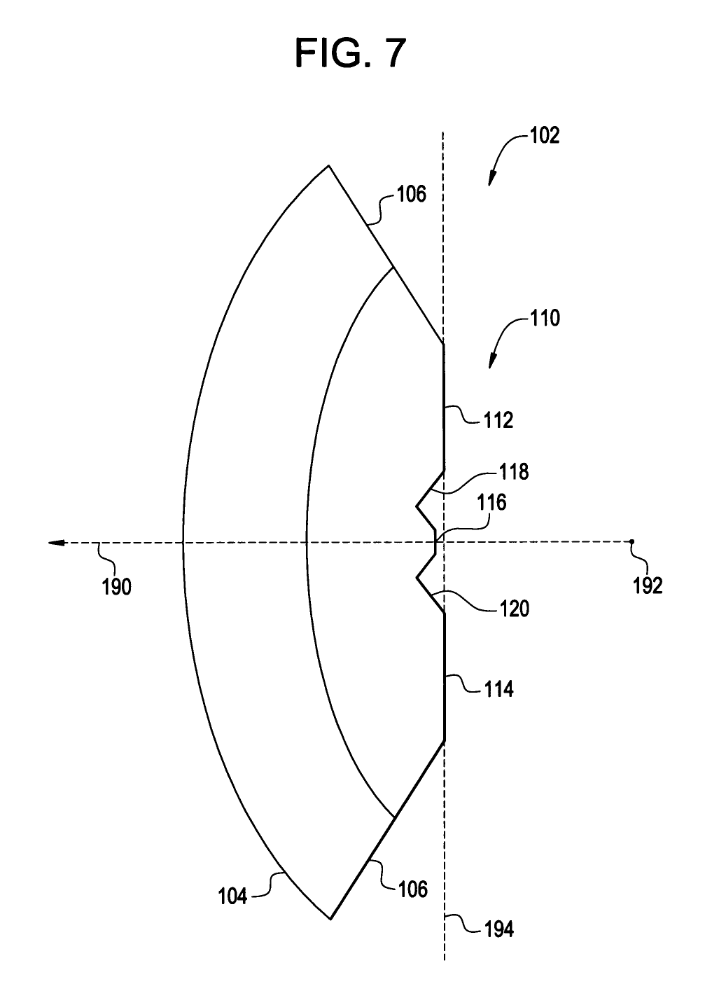

II. Example Embodiment Depicted in FIGS. 7-12:

In the previous example embodiment, the ridge 16 and the flats 12, 14 of the jaw face 10 may lie in a common reference plane 94 (which is parallel to the tool chuck axis 92). In the following example embodiment, the ridge may be recessed from the flats.

With reference to FIG. 7, the jaw 102 may include a jaw face 110 and a back surface 104 opposite the jaw face 110. Side surfaces 106 may extend between the back surface 104 and the jaw face 110.

The jaw face 110 may include a pair of flats 112, 114. The flats 112, 114 may be provided on either side of a jaw axis 190 that extends in a radial outward direction from a tool chuck axis 192 (which extends into the drawing sheet). The flats 112, 114 may be perpendicular to the jaw axis 190 and parallel to the tool chuck axis 192.

The jaw face 110 may also include a ridge 116 located between the flats 112, 114. The ridge 116 may be parallel to the tool chuck axis 192 and centered on the jaw axis 190. In this example embodiment, the ridge 116 may be recessed with respect to the flats 112, 114, which may lie in a common reference plane 194. By way of example only, the ridge 116 may be recessed via grinding the peak of the ridge 116. In this way, the ridge 116 may provide a larger contact surface than the ridge 16 depicted in FIG. 1. By virtue of the larger contact surface, the ridge 116 may provide improved runout characteristics with respect to round shank accessories. As is well known in this art, runout refers to the amount of misalignment (or deviation) of the axis of the accessory with the tool chuck axis.

Respective troughs 118, 120 may be situated between the ridge 116 and each of the flats 112, 114. Troughs having numerous and varied shapes may be suitably implemented. Further, the trough may have a uniform cross sectional shape, or the cross sectional shape may be varied along the length of the trough.

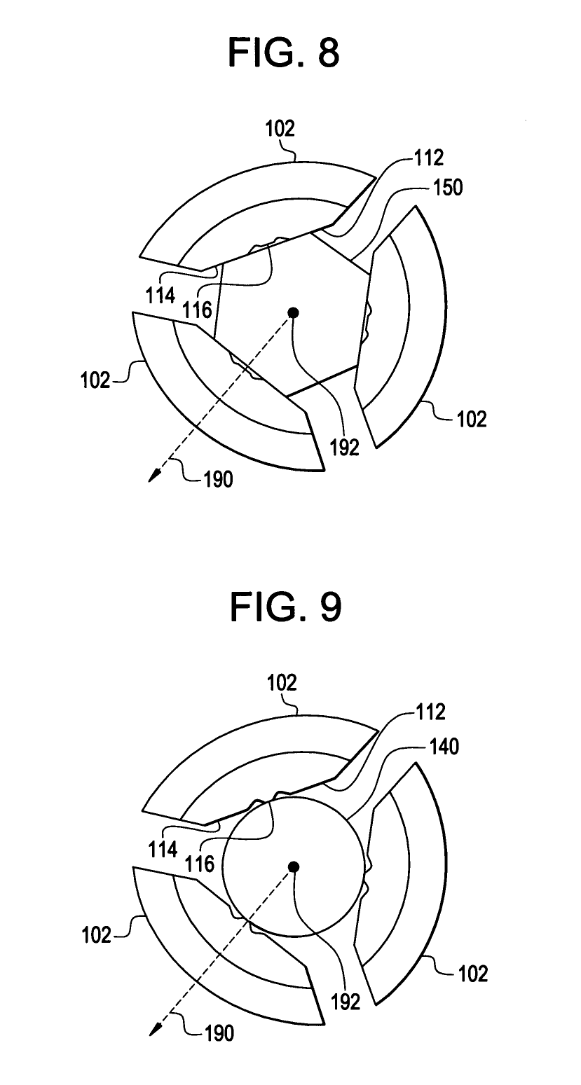

As described below with reference to FIGS. 8-12, accessories having smooth (or round) shanks may be gripped by the ridge 116 of the jaw face 110, and accessories having shanks with flats may be gripped by the flats 112, 114 of the jaw face 110. FIGS. 8-12 illustrate the spatial arrangement between the jaws 102 of a three-jaw chuck.

FIG. 8 illustrates the jaws 102 gripping an accessory having a relatively small hex shank 150 (e.g., a ¼″ hex shank). Here, the flats 112, 114 of each jaw 102 may grip the hex shank 150, while the ridge 116 of each jaw 102 may be spaced apart from the hex shank 150. In this way, the ridge 116 may not interfere with the engagement between the flats 112, 114 and the hex shank 150.

FIG. 9 illustrates the jaws 102 gripping an accessory having a relatively small round shank 140 (e.g., a ¼″ round shank). Here, the ridge 116 of each jaw 102 may grip the round shank 140, while the flats 112, 114 of each jaw 102 may be spaced apart from the round shank 140. In this way, the flats 112, 114 may not interfere with the “biting” action of the ridges 116 into the round shank 140.

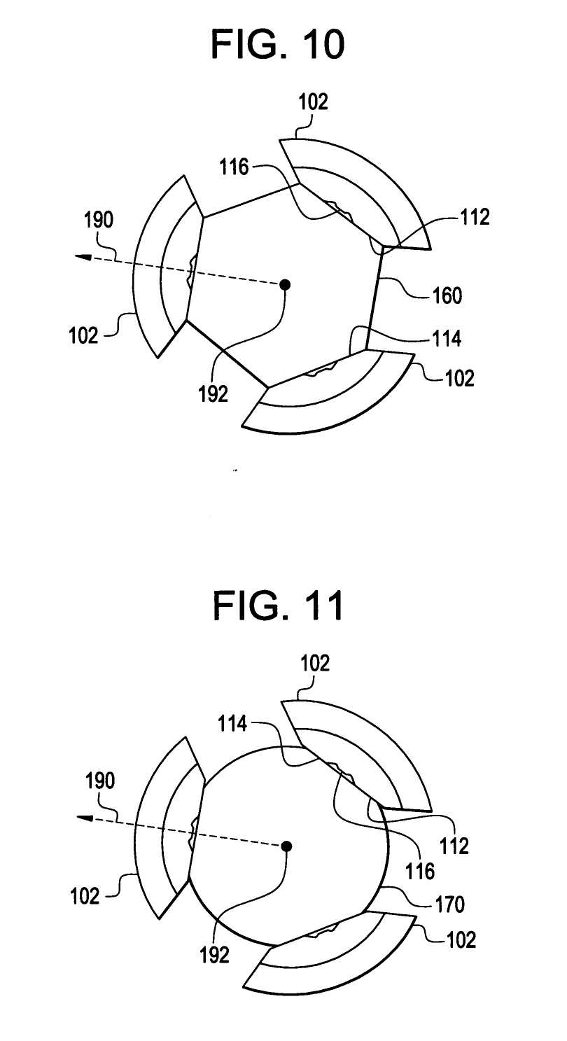

FIG. 10 illustrates the jaws 102 gripping an accessory having a relatively large hex shank 160 (e.g., a 7/16″ hex shank). Here, the flats 112, 114 of each jaw 102 may grip the hex shank 160, while the ridge 116 of each jaw 102 may be spaced apart from the hex shank 160.

FIG. 11 illustrates the jaws 102 gripping an accessory having a relatively large round shank 170 with flats (e.g., a ½″ round shank with flats). Here, the flats 112, 114 of each jaw 102 may grip the shank 170, while the ridge 116 of each jaw 102 may be spaced apart from the shank 170.

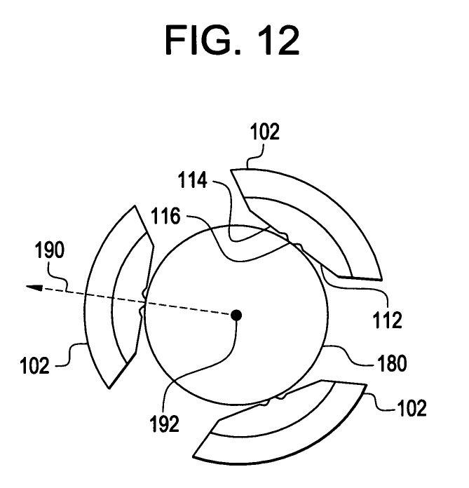

FIG. 12 illustrates the jaws 102 gripping an accessory having a relatively large round shank 180 (e.g., a ½″ round shank). Here, the ridge 116 of each jaw 102 may grip the round shank 180, while the flats 112, 114 of each jaw 102 may be spaced apart from the round shank 180. In this way, the flats 112, 114 may not interfere with the “biting” action of the ridges 116 into the round shank 180.

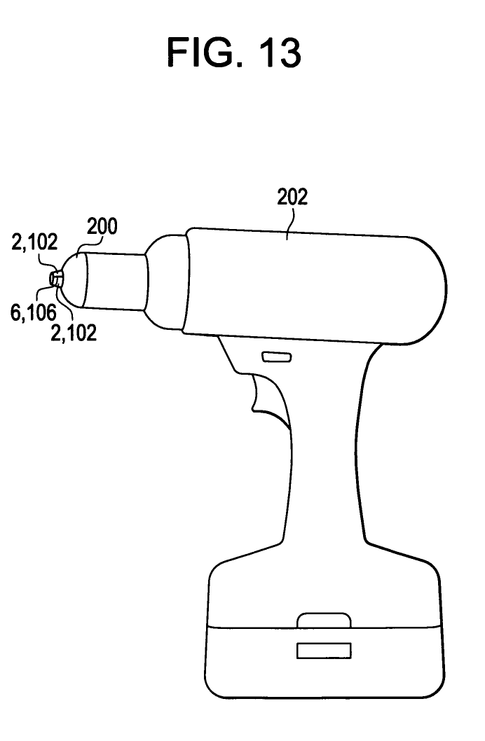

FIG. 13 illustrates a side view of jaws 2, 102 in accordance with any of the embodiments described above. The jaws 2, 102 are part of a three jaw chuck 200 on a power driver 202. As shown, the jaws 2, 102 are fully closed so that each side surface 6, 106 of the jaws 2, 102 abut against a side surface 6, 106 of another jaw 2, 102.

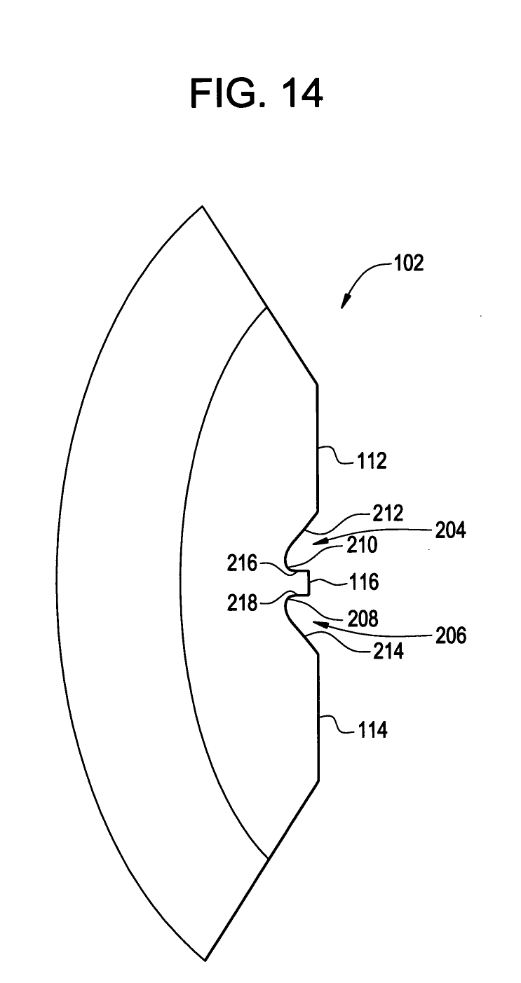

The troughs 18, 20, 118, and 120 shown in FIGS. 1-12 are substantially made of strait lines that meet at an angle. FIG. 14 illustrates an example of troughs 204 and 206 that are of a different shape. The troughs 204 and 206 have rounded sections 208 and 210 near the ridge 116. The rounded sections 208 and 210 may be substantially circular arcs that contact the diagonal and substantially strait sections 212 and 214 that connect the rounded sections 208 and 210 to the flats 112 and 114 and the strait sections 216 and 218 that connect the rounded sections 208 and 210 to the ridge 116. While only a few example troughs 18, 20, 118, 120, 204, and 206 can be shown and explained herein, the examples are not limiting. Most any suitability shaped trough can be used in accordance with the invention.

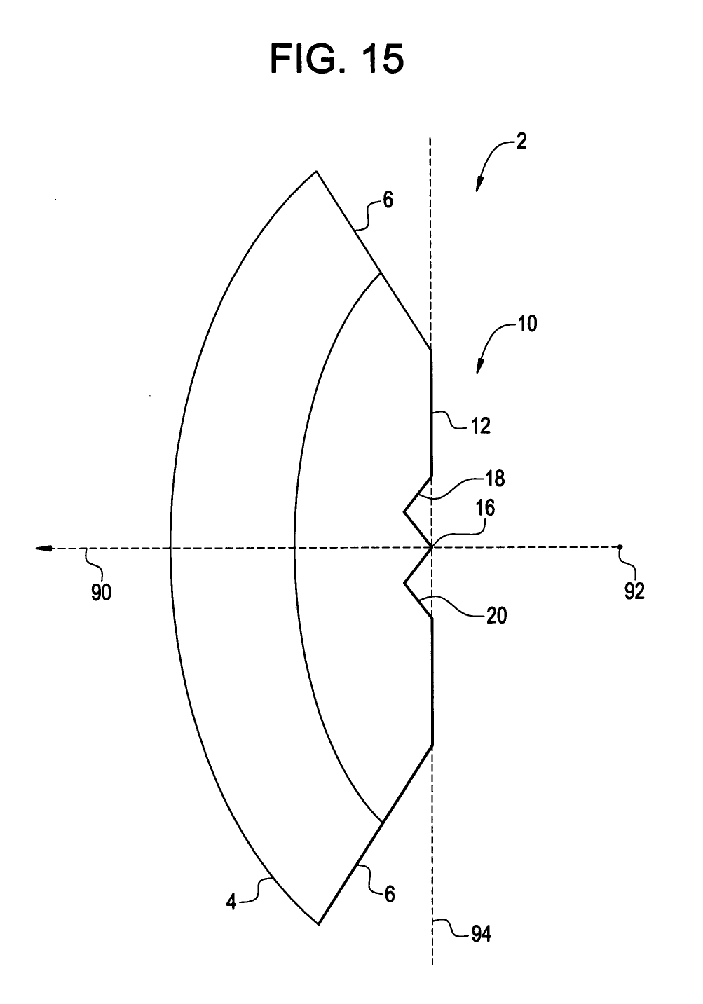

FIG. 15 shows an alternate example embodiment similar to that shown in FIG. 1. The difference between the embodiment in FIG. 1 and FIG. 15 is that the ridge 16 extents beyond the common reference plane 94. The other features of FIG. 15 are similar to that shown in FIG. 1 and will not be repeated here. In some embodiments in accordance with the invention, the ridge 16 may extend about 0.3 mm or less above the reference plane 94. In other embodiments it may extend other distances past the reference plane 94. In embodiments having a ridge 16 that extend above the flats 12 and 14 and past the reference plane 94 the ridge 16 may contact an accessory whether the accessory is equipped with flats or is a round shank. In some embodiments, the ridge 16 may sink into the sides of the accessory over the course of usage of the accessory with the chuck jaw 2.

In the example, non-limiting embodiments described above, the geometry of the jaw face may be such that only the ridge grips accessories with round shanks, while the flats (and maybe the ridge) grip accessories with shanks having flats. However, the example embodiments are not limited in this regard. For example, if small enough, a shaft with flats may be positioned between the flats of the jaw face. Here, the ridge of the jaw face may grip the flat of the shank. And if large enough, a round shaft may extend across and contact the ridge and the flats of the jaw face, or alternatively may extend across and contact the flats of the jaw face and bridge across (without contacting) the ridge of the jaw face. Jaws in accordance with some embodiments of the invention are not limited to the sample dimensions described above. Embodiments in accordance with the invention are not limited to example dimensions described herein. One skilled in the art after reviewing this disclosure will be able to scale appropriate dimensions in order to achieve an appropriately sized chuck and jaws that can clamp accessories of any desired size.

What is claimed is:

1. A chuck comprising:
a plurality of chuck jaws, each chuck jaw radially movable toward and way from a chuck axis, the each chuck jaw comprising:
two substantially coplanar surfaces perpendicular to a chuck jaw axis and substantially parallel to the chuck axis;
a ridge located between the two substantially coplanar surfaces; and
two troughs, one trough located between the ridge and one of the substantially coplanar surface and the other trough located between the ridge and the other coplanar surface.

2. The chuck of claim 1, wherein the chuck jaw axis extends through the ridge.

3. The chuck of claim 1, wherein a top surface of the ridge is substantially flat.

4. The chuck of claim 1, wherein the ridge has a slightly concave top surface.

5. The chuck of claim 1, wherein the ridge is pointed.

6. The chuck of claim 1, wherein a top surface of the ridge is substantially coplanar with the substantially coplanar surfaces.

7. The chuck of claim 1, wherein a top surface the ridge is recessed and does not break the plane defined by the substantially coplanar surfaces.

8. The chuck of claim 1, wherein the ridge and substantially coplanar surfaces are located and dimensioned such that when the chuck is engaged with a round shank, the ridges, but not the substantially coplanar surfaces of the jaws, contact the round shank.

9. The chuck of claim 1, wherein when the chuck engages with an accessory having flats, the substantially coplanar surfaces engage the flats.

10. The chuck of claim 1, wherein when the chuck is in a closed position, each chuck jaw contacts at least one other chuck jaw.

11. The chuck of claim 1, further comprising a power tool operatively connected to the chuck.

12. The chuck of claim 1, wherein the ridge extends through the plane defined by the substantially coplanar surfaces.

13. A method of configuring a chuck comprising:
providing a chuck jaw having a flat face, the flat face perpendicular to a chuck jaw axis and substantially parallel to a chuck axis;
defining a ridge in the chuck jaw by forming two troughs in the flat face running substantially parallel to the chuck axis; and
dimensioning and locating the ridge and the flat face so that when the chuck is engaged with a round shank, the ridge and not the flat face engages the shank and when the chuck engages an accessory with flats, the flat face engages the flats.

14. The method of claim 13, further comprising forming a substantially flat top portion on the ridge.

15. The method of claim 13, further comprising recessing the ridge from the flat surface so that the ridge does not break a plane defined by the flat surface.

16. The method of claim 13, further comprising forming substantially flat angled sides on the chuck jaw and angling the flat sides to abut an angled side of an adjacent chuck jaw when the jaws in the chuck are closed.

17. The method of claim 13, further comprising moving all of the chuck jaws radially to grip an accessory.

18. A chuck jaw comprising:
two substantially coplanar surfaces perpendicular to a chuck jaw axis and substantially parallel to the chuck axis;
a ridge located between the two substantially coplanar surfaces;
two troughs, one trough located between the ridge and one of the substantially coplanar surface and the other trough located between the ridge and the other coplanar surface; and
two flat angled sides, each of the two flat angled sides oriented at an angle that allows the flat angled sides to abut against a flat angled side of an adjunct chuck jaw when the jaws in the chuck are closed.

19. The chuck jaw of claim 18, wherein the angle that allows the flat angled sides to abut against a flat angled side of an adjacent chuck jaw when the jaws in the chuck are closed is about 120° with respect to chuck jaw axis.

20. The chuck jaw of claim 18, further comprising a second chuck jaw to form, at least in part, a chuck operatively connected to a power tool for clamping an accessory.

21. The chuck jaw of claim 20, wherein the ridge and the flat faces are dimensioned and located so that when the chuck is engaged with a round shank, the ridge and not the flat face engages the shank and when the chuck engages an accessory with flats, the flat face engages the flats.
